(19) United States
(12) Patent Application Publication
(10) Pub. No.: US 2022/0166751 A1
(43) Pub. Date: May 26, 2022

(54) PHONE CALL ENDPOINT SECURITY

(71) Applicant: Charter Communications Operating, LLC, St. Louis, MO (US)

(72) Inventor: Ashutosh K. Sinha, Centennial, CO (US)

(21) Appl. No.: 16/953,610

(22) Filed: Nov. 20, 2020

(51) Int. Cl. H04L 29/06; G06F 16/245; H04L 9/30

(52) U.S. Cl. CPC H04L 63/0236; H04L 65/1006; H04L 65/1069; H04L 9/30; H04L 63/1466; G06F 16/245; H04L 63/0442

(57) ABSTRACT

Disclosed herein is phone call endpoint security. In particular, the embodiments provide a mechanism to generate or modify a Session Initiation Protocol (SIP) invite message to include a phone number and an encrypted identifier that identifies a calling device. A network computing device decrypts the encrypted identifier and queries a database that correlates phone numbers to identifiers. The network computing device determines to forward or reject the SIP invite message based on whether the identifier and the phone number in the SIP invite message are correlated to one another in the database. Accordingly, the endpoint is secured, and calling devices are blocked from attempting to make deceptive phone calls from phone numbers not known to be associated with the calling device.

### BACKGROUND

Under certain circumstances a calling device may intentionally initiate a phone call that indicates to a called device that the phone call originates from a phone number not known to be associated with the calling device. This is sometimes referred to as “spoofing,” Such phone calls are problematic and generally undesirable as the person called is being deceived as to the identity of the caller.

### SUMMARY

The embodiments disclosed herein provide phone call endpoint security. In particular, the embodiments provide a mechanism to generate or modify a Session Initiation Protocol (SIP) invite message to include a phone number and an encrypted identifier that identifies a calling device. A network computing device decrypts the encrypted identifier and queries a database that correlates phone numbers to identifiers. The network computing device determines to forward or reject the SIP invite message based on whether the identifier and the phone number in the SIP invite message are correlated to one another in the database, Accordingly, the endpoint computing device is secured, and calling devices are blocked from attempting to make deceptive phone calls from phone numbers not known to be associated with the calling device.

In one embodiment, a network computing device is provided. The network computing device includes a memory and a processor device coupled to the memory. The processor device is configured to receive a session initiation protocol (SIP) invite message. The SIP invite message includes a header field comprising a phone number and an identifier that identifies a calling device. The processor device is further configured to query a database that correlates each of a plurality of phone numbers to a respective one of a plurality of identifiers. The processor device is further configured to determine to forward or reject the SIP invite message based on whether the identifier and the phone number in the SIP invite message are correlated to one another in the database.

In another embodiment, a method is provided. The method includes receiving, at a network computing device, a session initiation protocol (SIP) invite message. The SIP invite message includes a header field comprising a phone number and an identifier that identifies a calling device. The method further includes querying, by the network computing device, a database that correlates each of a plurality of phone numbers to a respective one of a plurality of identifiers. The method further includes determining, by the network computing device, to forward or reject the SIP invite message based on whether the identifier and the phone number in the SIP invite message are correlated to one another in the database.

In another embodiment, an endpoint computing device is provided. The endpoint computing device includes a memory and a processor device coupled to the memory. The processor device is configured to encrypt, using a public encryption key of a network computing device, an identifier that identifies a calling device to generate an encrypted identifier. The processor is further configured to generate a session initiation protocol (SIP) invite message that includes a phone number and the encrypted identifier. The processor is further configured to transmit the SIP invite message toward the network computing device.

Those skilled in the art will appreciate the scope of the disclosure and realize additional aspects thereof after reading the following detailed description of the embodiments in association with the accompanying drawing figures.

### BRIEF DESCRIPTION OF THE DRAWINGS

The accompanying drawing figures incorporated in and forming a part of this specification, illustrate several aspects of the disclosure and, together with the description, serve to explain the principles of the disclosure.

FIG. 1 is a block diagram of a system for phone call endpoint security illustrating certain aspects of various embodiments disclosed herein;

FIG. 2 is a flowchart illustrating processing steps for phone call endpoint security by a network computing device for determining whether to forward or reject a session initiation protocol (SIP) invite message;

FIG. 3 is a message sequence diagram illustrating example messages communicated between and actions taken by several of the elements illustrated in FIG. 1, according to one embodiment;

FIG. 4 is a block diagram illustrating another embodiment of the system of FIG. 1 with an Embedded Multimedia Terminal Adapter (eMTA) as the endpoint computing device;

FIG. 5 is a block diagram illustrating another embodiment of the system of FIG. 1 with an Enterprise Session Border Controller (E-SBC) as the endpoint computing device;

FIG. 6 is a block diagram illustrating another embodiment of the system of FIG. 1 with a 4G mobile device as the endpoint computing device;

FIG. 7 is a block diagram illustrating another embodiment of the system of FIG. 1 with a 5G mobile device as the endpoint computing device; and

FIG. 8 is a block diagram of a computing device suitable for implementing one or more of the processing devices disclosed herein, according to one embodiment.

### DETAILED DESCRIPTION

The embodiments set forth below represent the information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the embodiments are not limited to any particular sequence of steps. The use herein of ordinals in conjunction with an element is solely for distinguishing what might otherwise be similar or identical labels, such as “first message” and “second message,” and does not imply a priority, a type, an importance, or other attributes, unless otherwise stated herein. The term “about” used herein in conjunction with a numeric value means any value that is within a range of ten percent greater than or ten percent less than the numeric value.

As used herein and in the claims, the articles “a” and “an” in reference to an element refers to “one or more” of the element unless otherwise explicitly specified. The word “or” as used herein and in the claims is inclusive unless contextually impossible. For example, the recitation of A or B means A, or B, or both A and B.

Under certain circumstances a calling device may intentionally initiate a phone call that indicates to a called device that the phone call originates from a phone number not known to be associated with the calling device. This is sometimes referred to as “spoofing.” Such phone calls are problematic and generally undesirable as the person called is being deceived as to the identity of the caller.

The embodiments disclosed herein implement mechanisms for securing an endpoint computing device of a network to block calling devices from using phone numbers not known to be associated with the calling device. In particular, the endpoint computing device modifies or generates a Session Initiation Protocol (SIP) invite message to include an encrypted identifier that uniquely identifies the endpoint computing device. A network computing device (e.g., IP Multimedia Subsystem (IMS) server) decrypts the encrypted identifier and queries a database that correlates identifiers and phone numbers. Accordingly, the endpoint computing device is secured, and calling devices are blocked from attempting to make deceptive phone calls using phone numbers not known to be associated with the calling device.

Some security measures have been proposed to better label suspect phone calls. For example, STIR/SHAKEN (Secure Telephony Identity Revisited/Signature-based Handling of Asserted information using toKENs) is a suite of protocols and procedures to prevent spoofing on public telephone networks. Spoofing masks the identity of the caller (e.g., by appearing to come from a similar area code or a government agency). STIR/SHAKEN uses authentication and verification between telephone service providers to prevent such spoofing. The STIR/SHAKEN protocol then labels the call with a level of attestation based on whether the call came from a known phone number, a customer, and/or a gateway. However, additional security measures are needed to prevent these calls from being made in the first place. In particular, additional security measures are needed to prevent calling devices from using phone numbers not known to be associated with the calling device (e.g., assuming the identity of a customer of an operator to place deceptive calls).

The embodiments provided herein facilitate an improvement to computer functionality by providing a system that secures an endpoint computing device of a network, thereby preventing calling devices from using phone numbers not known to be associated with the calling device (e.g., assuming the identity of a customer of an operator to place deceptive calls). In other words, the embodiments increase network security for voice calls. Thus, the examples are directed to specific improvements in computer functionality.

The embodiments provided herein employ a new kind of protocol that enables computing devices to secure an endpoint computing device of a network to prevent calling devices from using phone numbers not known to be associated with the calling device (e.g., assuming the identity of legitimate customers of an operator to place deceptive calls). Such functionality was not previously available to such computing devices. Accordingly, the embodiments discussed herein are directed to a non-abstract improvement in computer functionality.

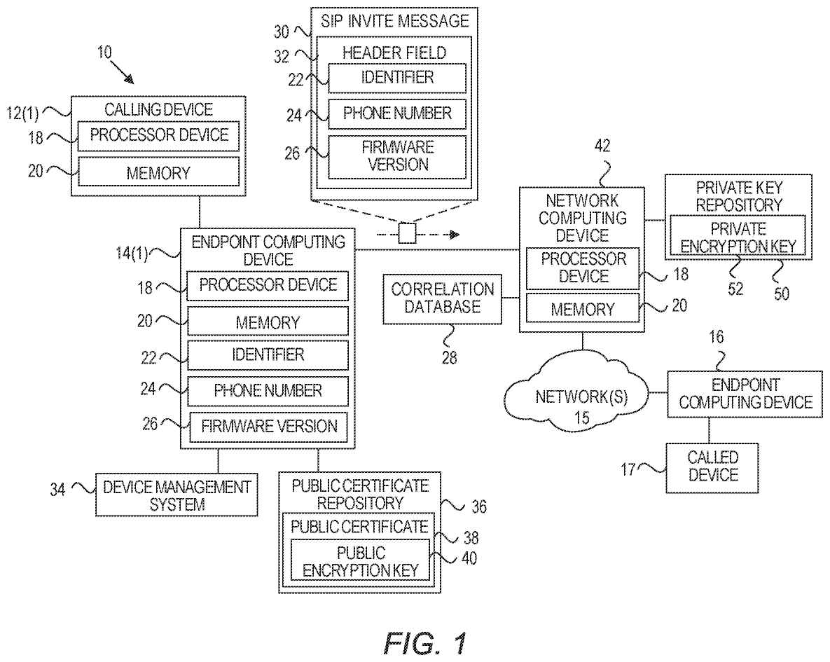

FIG. 1 is a block diagram of a system 10 for phone call endpoint security, illustrating certain aspects of various embodiments disclosed herein. The system 10 includes a calling device 12(1) and a first endpoint computing device 14(1) that communicate through a network 15 to a second endpoint computing device 16 and a called device 17 to establish a voice call. In certain embodiments, each of the calling device 12(1), the endpoint computing devices 14(1), 16, and/or the called device 17 includes a processor device 18 and a memory 20 coupled to the processor device 18. In certain embodiments, the system 10 uses an IP Multimedia Subsystem (IMS) as an architectural framework for establishing the voice call. In certain embodiments, the system 10 incorporates Transport Layer Security (TLS) and/or Internet Protocol Security (IPsec).

The calling device 12(1) (may also be referred to as an end-user computing device) may comprise any suitable device capable of initiating a phone call, such as, by way of non-limiting example, a desktop computer, laptop computer, tablet computer, smartphone, etc. In some embodiments, the calling device 12(1) operates as a softphone, SIP phone, voice-over-Internet-protocol (VOIP) phone, smartphone, etc. In certain embodiments, the endpoint computing device 14(1) operates as the calling device 12(1). The endpoint computing device 14(1) includes an embedded multimedia terminal adapter (eMTA), an enterprise session border controller (E-SBC), or a mobile device (e.g., 4G mobile device, 5G mobile device), etc.

The endpoint computing device 14(1) includes an identifier 22, a phone number 24, and a firmware version 26. In some embodiments (e.g., enterprise applications), the identifier 22 and the phone number 24 are associated with the calling device 12(1) so that the endpoint computing device 14(1) is in communication with a plurality of calling devices 12(1), each with their own identifier 22 and phone number 24. In such a configuration, the endpoint computing device 14(1) receives the phone number 24 and the identifier 22 from the calling device 12(1). In other embodiments, the identifier 22 is uniquely associated with the endpoint computing device 14(1) (and accordingly indirectly uniquely associated with the calling device 12(1)). The identifier 22 may be immutably associated with the endpoint computing device 14(1) (and accordingly indirectly uniquely associated with the calling device 12(1)). In some embodiments, the identifier 22 is directly uniquely associated and/or directly immutably associated with the calling device 12(1).

The identifier 22 may include, by way of non-limiting example, one or more of a device identifier (ID) of the calling device 12(1), a Media Access Control (MAC) address of the calling device 12(1), or a serial number of the calling device 12(1). A device ID is a string of numbers and letters stored on a mobile device that identifies individual smartphones and tablets. For example, a device ID may include an Identity for Advertisers (IDFA) on iOS devices and/or a Google Play Services ID for Android (GPS ADID) on Android devices. A MAC address is a unique identifier assigned to a network interface controller (NIC) for use as a network address. A serial number is a unique identifier assigned to a device to uniquely identify the device.

In some embodiments the endpoint computing device 14(1) communicates with a correlation database 28 to receive and/or report firmware patches or updates. The correlation database 28 stores data and may also provide additional functionality. In certain embodiments, the correlation database 28 is an enhanced Home Subscriber Server (HSS), enhanced Equipment Identity Register (EIR), and/or a device management system. An HSS is a master user database that supports IMS network entities that handle calls and sessions. The HSS contains user-profiles and performs authentication and authorization of a user. An EIR is a database of International Mobile Equipment Identity (NEI) numbers that correspond to physical handsets (not subscribers). The FIR database may be configured to store a wireless phone number, IMEI number, software version, and/or listing status (e.g., black, white, grey). The EIR database may be configured (for a fixed-line network) to store a MAC address, device ID, and/or serial number instead of an IMEI number. A device management system dynamically provisions and manages public certificates (e.g., by provisioning Public Certificate Repository Uniform Resource Locators (URLs)).

In certain embodiments, when a subscriber orders a fixed-line phone connection, operators will provide a subscriber profile with the identifier 22 of the endpoint computing device 14(1). In certain embodiments, the endpoint computing device 14(1) informs the correlation database 28 when the firmware of the endpoint computing device 14(1) is upgraded or updated.

The endpoint computing device 14(1) is configured to generate a SIP invite message 30 to establish a voice call over the network 15, The SIP invite message 30 includes a header field 32, including the identifier 22 of the calling device 12(1), the phone number 24 of the calling device 12(1), and/or the firmware version 26 of the calling device 12(1). It is noted that in certain embodiments, the identifier 22, the phone number 24, and/or the firmware version 26 may be directly associated with the endpoint computing device 14(1) and thereby indirectly associated with the calling device 12(1). In certain embodiments, the endpoint computing device 14(1) may receive a SIP invite message 30 from the calling device 12(1), and the endpoint computing device 14(1) may modify the SIP invite message 30 to include or modify the header field 32 (e.g., to include the identifier 22, the phone number 24, and/or the firmware version 26).

In certain embodiments, the endpoint computing device 14(1) is configured to encrypt the header field 32 (e.g., the identifier 22, the phone number 24, and/or the firmware version 26). In certain embodiments, the endpoint computing device 14(1) is configured to encrypt the identifier 22 but not the phone number 24 (as the phone number 24 may be provided elsewhere within the SIP invite message 30). In certain embodiments, the endpoint computing device 14(1) is in communication with a device management system 34. The device management system 34 dynamically provisions and manages public certificates 38 (e.g., by provisioning Public Certificate Repository URLs). In certain embodiments, the endpoint computing device 14(1) is in electronic communication with a public certificate repository 36, including a plurality of public certificates 38. The endpoint computing device 14(1) accesses the public certificate repository 36 by a pre-defined configuration as a static URL from an initial configuration file or can be dynamically provisioned by the device management system 34.

Each public certificate 38 includes a public encryption key 40 for encryption. The endpoint computing device 14(1) retrieves a public certificate 38 with a public encryption key 40 associated with a network computing device 42 (e.g., IMS server) to transmit an encrypted identifier 22 to the network computing device 42. In particular, in certain embodiments, the endpoint computing device 14(1) encrypts, using a public encryption key 40 of the network computing device 42, the identifier 22 that identifies the calling device 12(1) to generate an encrypted identifier 22. The endpoint computing device 14(1) then generates a SIP invite message 30 that includes the phone number 24 and the encrypted identifier 22 and transmits the SIP invite message 30 toward the network computing device 42.

The network computing device 42 may comprise any server or component in the IMS network, such as, by way of non-limiting example, a Call Session Control Function (CSCF). In certain embodiments, the endpoint computing device 14(1) transmits the SIP invite message 30 to the CSCF of the network computing device 42. The CSCF includes a Proxy Call Session Control Function (P-CSCF), Interrogating Call Session Control Function (I-CSCF), and Serving Call Session Control Function (S-CSCF). The P-CSCF is a first contact point of the IMS and functions as a proxy server to validate and forward requests, The I-CSCF is responsible for routing SIP invite messages 30 to the appropriate S-CSCF for a given subscriber. The S-CSCF is responsible for session control in the IMS, Subscribers are allocated an S-CSCF to facilitate routing of SIP invite messages 30. In certain embodiments, a single network computing device 42 includes the P-CSCF, the I-CSCF, and/or the S-CSCF. In other embodiments, a plurality of network computing devices provides the functionality of the P-CSCF, the I-CSCF, and/or the S-CSCF.

In particular, the endpoint computing device 14(1) transmits the SIP invite message 30 to the P-CSCF of the network computing device 42. In certain embodiments, the network computing device 42 includes a Representational State Transfer (RESTful) Hypertext Transfer Protocol (HTTP) interface to query the correlation database 28. In certain embodiments, the network computing device 42 queries using an HTTP verb GET, and the correlation database 28 returns a JavaScript Object Notation (JSON) object by a SIP 200 OK message. Similarly, updating the correlation database 28 may be provided by a RESTful HTTP interface to transmit, via HTTP verb PATCH, a JSON object with a new firmware release version value.

In certain embodiments, the network computing device 42 (e.g., P-CSCF or S-CSCF) is in communication with a private encryption key repository 50 to retrieve a private encryption key 52 stored therein. The network computing device 42 decrypts the encrypted identifier 22 using the private encryption key 52. Once decrypted, the network computing device 42 (e.g., P-CSCF or S-CSCF) queries the correlation database 28 to determine whether the identifier 22 and the phone number 24 of the SIP invite message 30 are correlated in the correlation database 28. The correlation database 28 correlates each phone number 24 with each identifier 22 (and/or firmware version 26). In certain embodiments, the network computing device 42 transmits the phone number 24 to the correlation database 28 and the correlation database 28 transmits the identifier 22 associated with that phone number 24 in the correlation database 28. In other words, the network computing device 42 receives the SIP invite message 30, which includes the header field 32 including the phone number 24 and the identifier 22 that identifies the calling device 12(1). The network computing device 42 then queries the correlation database 28, which correlates each of a plurality of phone numbers to a respective one of a plurality of identifiers.

The network computing device 42 then determines to forward or reject the SIP invite message 30 based on whether the identifier 22 and the phone number 24 in the SIP invite message 30 are correlated to one another in the correlation database 28. In particular, if the network computing device 42 confirms that the identifier 22 and the phone number 24 in the SIP invite message 30 are correlated to one another in the correlation database 28, the network computing device 42 transmits the SIP invite message 30 toward the network 15. In certain embodiments, the network computing device 42 modifies the SIP invite message 30 by removing the header field 32 or portions thereof (e.g., the identifier 22, the phone number 24, and/or the firmware version 26) to generate a modified SIP invite message 30 and then transmits the modified SIP invite message 30. If the network computing device 42 confirms that the identifier 22 and the phone number 24 in the SIP invite message 30 are not correlated in the correlation database 28, then the network computing device 42 rejects the SIP invite message 30. In certain embodiments, the network computing device 42 transmits a 403 Forbidden message to the endpoint computing device 14(1). The 403 Forbidden message indicates that the network computing device 42 understood the request but refused to authorize the request.

In certain embodiments, the P-CSCF provides the above functionality of the network computing device 42 in coordination with an EIR as the correlation database 28. In certain embodiments, the S-CSCF provides the above functionality of the network computing device 42 in coordination with a device management system as the correlation database 28.

The endpoint computing device 14(1) is configured to establish a call session or receive a rejection based on whether the identifier 22 and the phone number 24 of the SIP invite message 30 are correlated in the correlation database 28 in electronic communication with the network computing device 42. The correlation between the identifier 22 and the phone number 24 in the correlation database 28, and the features described above, prevent calling devices from using phone numbers 24 not known to be associated with the calling device (e.g., assuming the identity of a customer of an operator to place deceptive calls).

In certain embodiments, after confirming the correlation between the identifier 22 and the phone number 24 in the correlation database 28, the network computing device 42 modifies the SIP invite message 30 for compliance with STIRISHAKEN (Secure Telephony Identity Revisited/Signature-based Handling of Asserted information using toKENs) for transmission to the second endpoint computing device 16. In certain embodiments, the endpoint computing device 14(1) uses header fields used in the STIRISHAKEN protocol. For example, in certain embodiments, the endpoint computing device 14(1) modifies a SIP identity header field compliant with STIRISHAKEN to include the identifier 22 and the phone number 24.

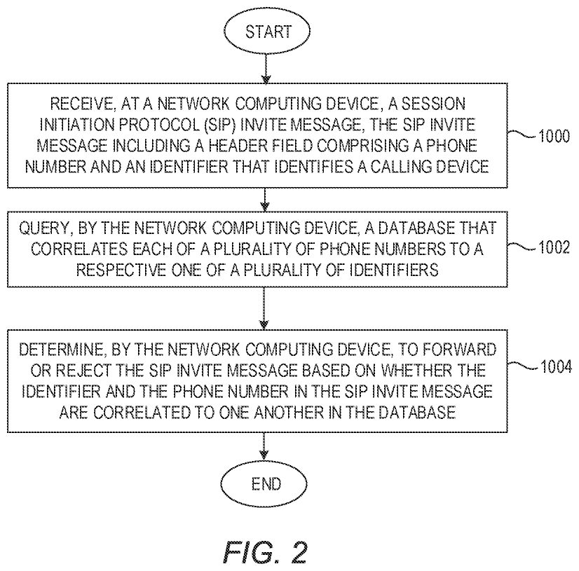

FIG. 2 is a flowchart for phone call endpoint security illustrating processing steps by the network computing device 42 of FIG. 1 to determine whether to forward or reject a SIP invite message 30. The network computing device 42 receives a SIP invite message 30. The SIP invite message 30 includes a header field 32, including a phone number 24 and an identifier 22 that identifies a calling device 12(1) (1000). The network computing device 42 queries a database (e.g., correlation database 28) that correlates each of a plurality of phone numbers 24 to a respective one of a plurality of identifiers 22 (1002). The network computing device 42 determines to forward or reject the SIP invite message 30 based on whether the identifier 22 and the phone number 24 in the SIP invite message 30 are correlated to one another in the database (e.g., correlation database 28) (1004).

In certain embodiments, the network computing device 42 determines whether to forward the SIP invite message 30 by confirming the identifier 22 and the phone number 24 in the SIP invite message 30 are correlated in the correlation database 28. Further, the network computing device 42 modifies the SIP invite message 30 by removing the identifier 22 and the phone number 24 to generate a modified SIP invite message 30. Further, the network computing device 42 transmits, by the network computing device 42, the modified SIP invite message 30. In certain embodiments, the SIP invite message 30 is not modified to remove the identifier 22 and/or the phone number 24. In certain embodiments, the network computing device 42 determines whether to reject the SIP invite message 30 by confirming the identifier 22 and the phone number 24 in the SIP invite message 30 are not correlated in the correlation database 28, and rejecting the SIP invite message 30.

In certain embodiments, the header field 32 of the SIP invite message 30 includes the firmware version 26. In certain embodiments, the identifier 22 includes one or more of the device ID of the network computing device 42, the MAC address of the network computing device 42, or the serial number of the computing device network computing device 42. In certain embodiments, the SIP invite message 30 is received at the P-CSCF or the S-CSCF of the network computing device 42. In certain embodiments, the SIP invite message 30 is received from the endpoint computing device 14(1), including one or more of an eMTA or a mobile device. In certain embodiments, the correlation database 28 is one or more of an HSS, an EIR, or a device management system. In certain embodiments, the identifier 22 includes an encrypted identifier 22 that is encrypted by the public encryption key 40 of the network computing device 42, and the network computing device 42 decrypts the encrypted identifier 22 using the private encryption key 52 of the computing device network computing device 42.

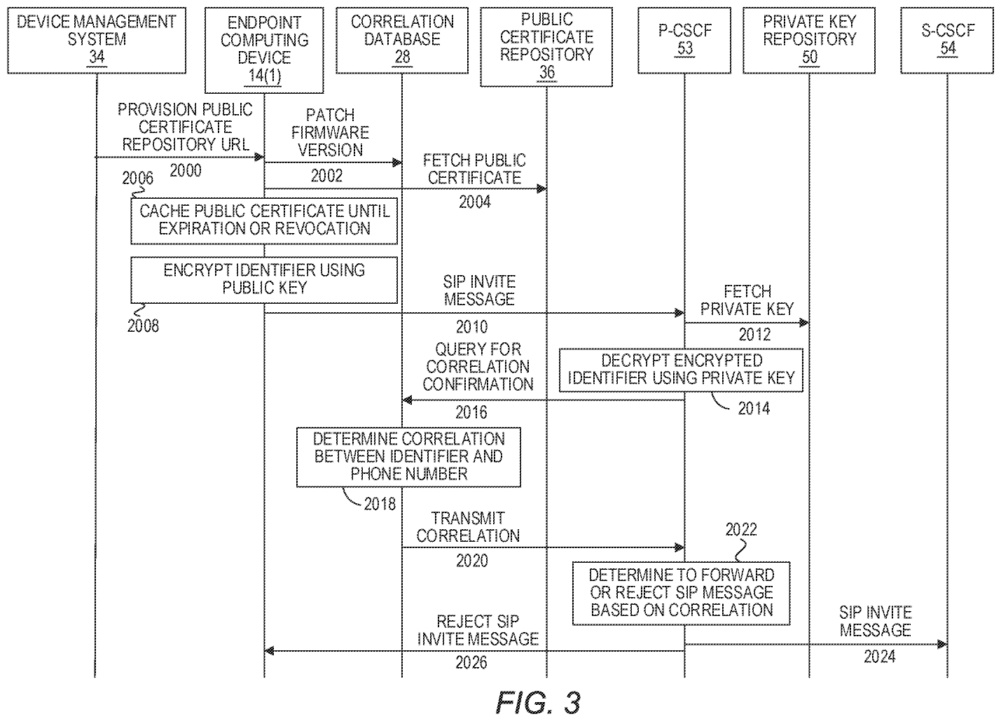

FIG. 3 is a message sequence diagram illustrating example messages communicated between and actions taken by several of the elements illustrated in FIG. 1, according to one embodiment. In this embodiment, the device management system 34 provisions a public certificate repository URL to the endpoint computing device 14(1) (2000). The endpoint computing device 14(1) communicates with the correlation database 28 to patch a firmware version (2002), To communicate with the network computing device 42, the endpoint computing device 14(1) fetches the public certificate 38 (see FIG. 1) from the public certificate repository 36 (2004). The endpoint computing device 14(1) then caches the public certificate 38 until expiration or revocation (e.g., via a certificate revocation list (CRL)) (2006). To send a SIP invite message 30 (see FIG. 1), the endpoint computing device 14(1) encrypts the identifier 22 (see FIG. 1) using the public encryption key 40 (see FIG. 1) of the public certificate 38 of the network computing device 42 (2008). The endpoint computing device 14(1) generates or modifies the SIP invite message 30 to include the encrypted identifier 22 (in a header field 32). The endpoint computing device 14(1) transmits the SIP invite message 30 to the P-CSCF 53 of the network computing device 42 (2010). The P-CSCF 53 fetches the private encryption key 52 from the private encryption key repository 50 (2012). The P-CSCF 53 uses the private encryption key 52 to decrypt the encrypted identifier 22 (2014).

The P-CSCF 53 then queries the correlation database 28 for correlation confirmation (2016). The correlation database 28 determines a correlation between the identifier 22 and the phone number 24 (2018). For example, in certain embodiments, the P-CSCF 53 transmits the phone number 24 and requests the associated identifier 22 stored in the correlation database 28. The P-CSCF 53 then determines to forward or reject the SIP invite message 30 based on the correlation (2022). For example, in certain embodiments, the identifier 22 associated with the SIP invite message 30 differs from the identifier 22 returned by the correlation database 28.

If the phone number 24 and the identifier 22 are correlated in the correlation database 28, then the SIP invite message 30 is transmitted toward the SCSCF 54 (2022). If instead, the phone number 24 and identifier 22 differ between the SIP invite message 30 and the correlation database 28, then the SIP invite message 30 is rejected (2024). For example, in certain embodiments, a 403 Forbidden message is transmitted to the endpoint computing device 14(1).

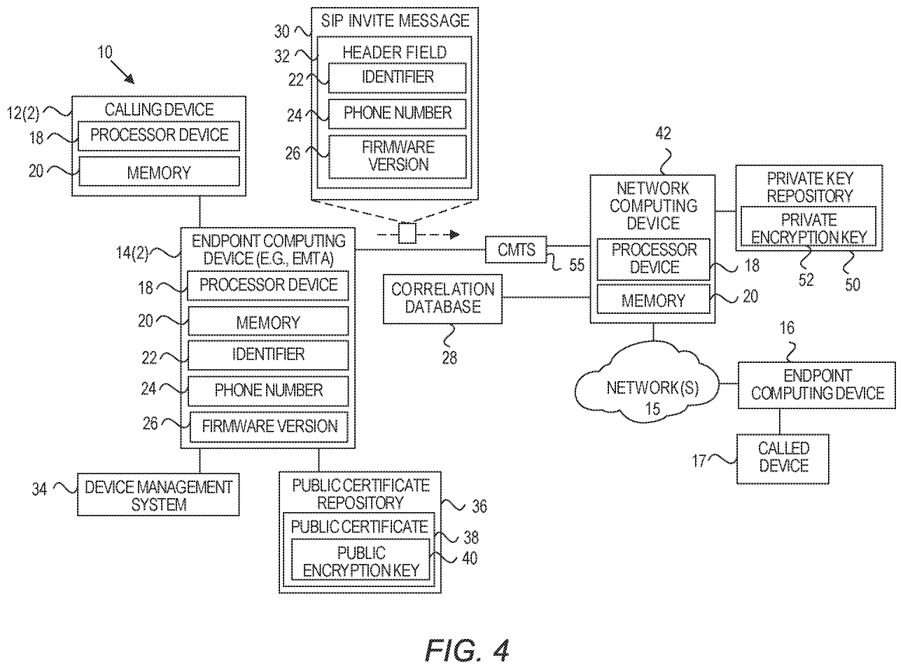

FIG. 4 is a block diagram illustrating another embodiment of the system of FIG. 1 with an eMTA 14(2). The eMTA 14(2) is a cable modem with an analog telephone adapter (ATA). The eMTA 14(2) is connected to a fixed-line network and enhanced to support Public Key Infrastructure (PKI) mechanisms. In such a configuration, the eMTA 14(2) is associated with the identifier 22 and the phone number 24 and in communication with the calling device 12(2). The eMTA 14(2) is in communication with a cable modem termination system (CMTS) 55. The CMTS 55 provides cable internet and/or VOIP to cable subscribers. The CMTS 55 is in communication with the network computing device 42 (e.g., using Packet Cable Multimedia (PCMM)). PCMM is an interface for using IP networks to deliver multimedia services (e.g., IP telephony) on a cable television infrastructure.

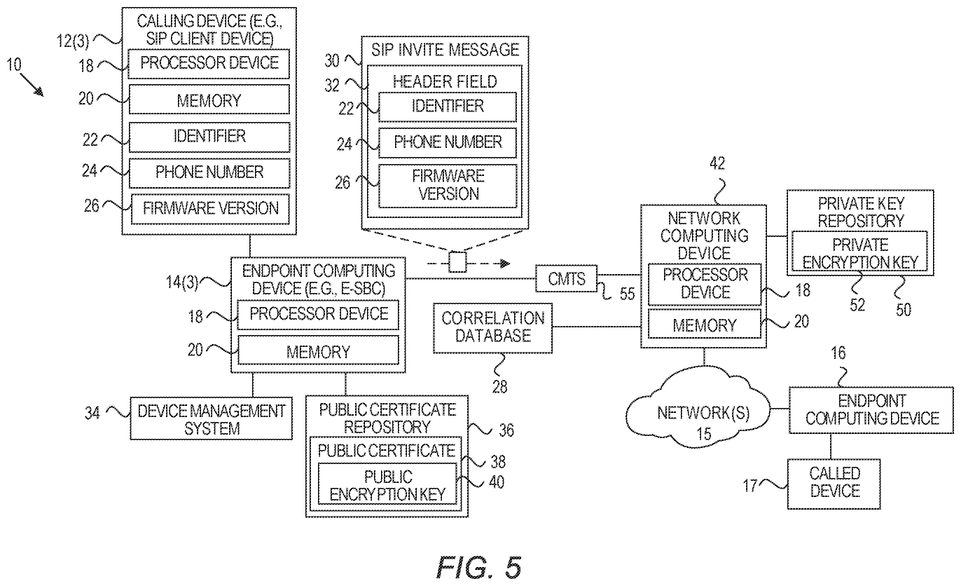

FIG. 5 is a block diagram illustrating another embodiment of the system of FIG. 1 with an E-SBC 14(3). In this embodiment, the calling device is embodied as a SIP client device 12(3), and the endpoint computing device is embodied as an E-SBC device 14(3). The E-SBC device 14(3) communicates with a plurality of SIP client devices 12(3). In the correlation database 28, an identifier 22 of each SIP client device 12(3) is associated with a phone number 24 of each SIP client device 12(3). Accordingly, each SIP client device 12(3) transmits an identifier 22 and a phone number 24 along with a SIP invite message 30. The E-SBC device 14(3) then transmits the SIP invite message 30 to the CMTS 55.

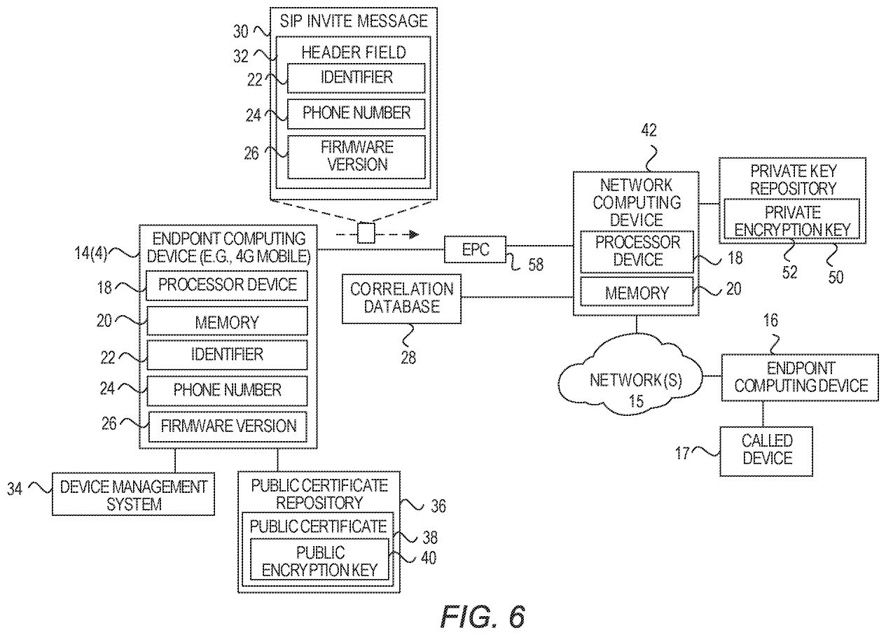

FIG. 6 is a block diagram illustrating another embodiment of the system of FIG. 1 with a 4G mobile device 14(4). In this embodiment, the calling device and the endpoint computing device are the same, embodied as the 4G mobile device 14(4). The 4G mobile device 14(4) is in communication with an evolved packet core (EPC) 58 (may also be referred to as a system architecture evolution (SAE) core). The EPC 58 provides converged voice and data on a 4G long-term evolution (LTE) network. The EPC 58 is in communication with the network computing device 42 (e.g., via a policy and charging rules function (PCRF)). The PCRF determines policy rules in a multimedia network. The PCRF accesses subscriber databases in a centralized manner. In particular, PCRF acts as a mediator of network resources for the IMS network for establishing calls.

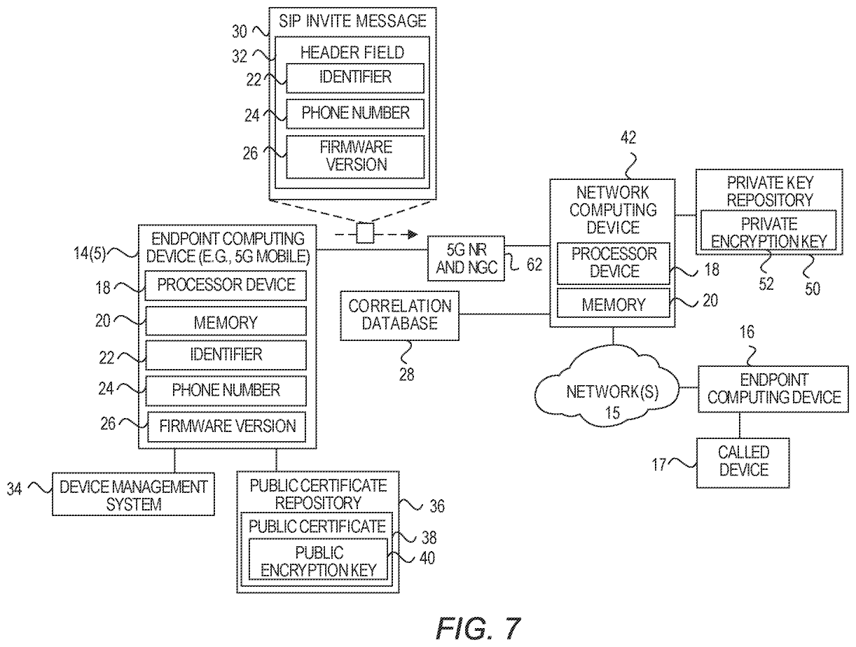

FIG. 7 is a block diagram illustrating another embodiment of the system of FIG. 1 with a 5G mobile device 14(5). As with the embodiment of FIG. 6, the calling device and the endpoint computing device are the same, embodied as the 5G mobile device 14(5). The 5G mobile device 14(5) is in communication with a 5G new radio (NR) and next-generation core (NGC) 62. A 5G NR is a standard for new orthogonal frequency-division multiplexing (OFDM)-based air interface to support 5G devices. The NGC is the part of the 5G network that provides services to mobile subscribers. The 5G NR and NGC 62 is in communication with the network computing device 42 (e.g., via a policy control function (PCF)). The PCF performs the same function as the PCRF in 4G networks.

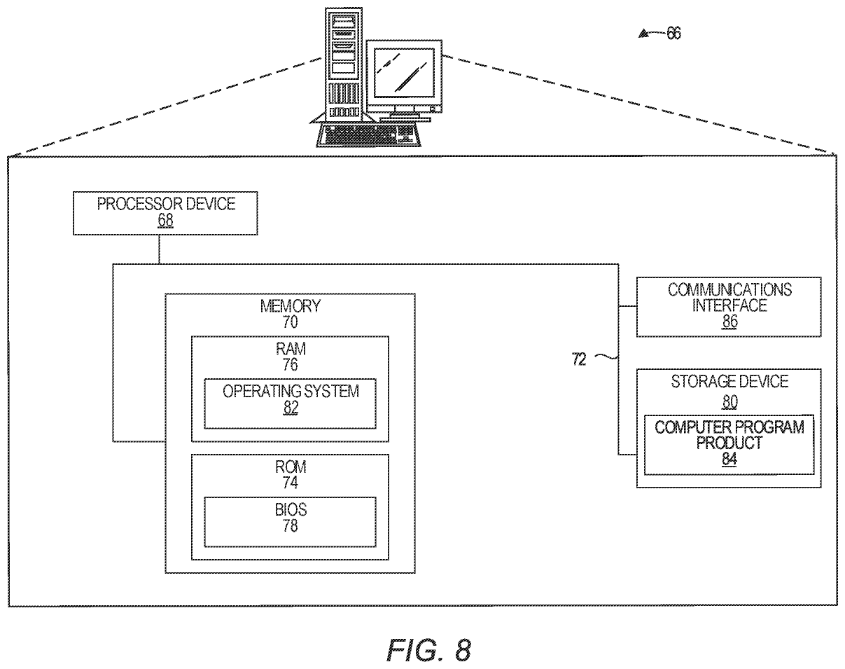

FIG. 8 is a block diagram of a computing device 66 containing components suitable for implementing any of the processing devices disclosed herein. The computing device 66 includes a processor device 68, a system memory 70, and a system bus 72. The system bus 72 provides an interface for system components including, but not limited to, the system memory 70 and the processor device 68. The processor device 68 can be any commercially available or proprietary processor.

The system bus 72 may be any of several types of bus structures that may further interconnect to a memory bus (with or without a memory controller), a peripheral bus, and/or a local bus using any of a variety of commercially available bus architectures. The system memory 70 may include non-volatile memory 74 (e.g., read-only memory (ROM), erasable programmable read-only memory (EPROM), electrically erasable programmable read-only memory (EEPROM), etc.), and volatile memory 76 (e.g., random-access memory (RAM)). A basic input/output system (BIOS) 78 may be stored in the non-volatile memory 74 and can include the basic routines that help transfer information between dements within the source computing device 66. The volatile memory 76 may also include a high-speed RAM, such as static RAM, for caching data.

The computing device 66 may further include or be coupled to a non-transitory computer-readable storage medium such as the storage device 80, which may comprise, for example, an internal or external hard disk drive (HOD) (e.g., enhanced integrated drive electronics (EIDE) or serial advanced technology attachment (SATA)), HDD (e.g., EIRE or SATA) for storage, flash memory, or the like. The storage device 80 and other drives associated with computer-readable media and computer-usable media may provide non-volatile storage of data, data structures, computer-executable instructions, and the like.

A number of modules can be stored in the storage device 80 and in the volatile memory 76, including an operating system 82 and one or more program modules which may implement the functionality described herein in whole or in part. All or a portion of the examples may be implemented as a computer program product 84 stored on a transitory or non-transitory computer-usable or computer-readable storage medium, such as the storage device 80, which includes complex programming instructions, such as complex computer-readable program code, to cause the processor device 68 to carry out the steps described herein. Thus, the computer-readable program code can comprise software instructions for implementing the functionality of the examples described herein when executed on the processor device 68. The processor device 68, in conjunction with the network manager in the volatile memory 76, may serve as a controller or control system for the computing device 66 that is to implement the functionality described herein.

The computing device 66 may also include one or more communication interfaces 86, depending on the particular functionality of the computing device 66. The communication interfaces 86 may comprise one or more wired Ethernet transceivers, wireless transceivers, fiber, satellite, and/or coaxial interfaces, by way of non-limiting example.

Those skilled in the art will recognize improvements and modifications to the preferred embodiments of the disclosure. All such improvements and modifications are considered within the scope of the concepts disclosed herein and the claims that follow.

What is claimed is:

1. A network computing device, comprising:
a memory; and
a processor device coupled to the memory and configured to:
receive a session initiation protocol (SIP) invite message, the SIP invite message including a header field comprising a phone number and an identifier that identifies a calling device;
query a database that correlates each of a plurality of phone numbers to a respective one of a plurality of identifiers; and
determine to forward or reject the SIP invite message based on whether the identifier and the phone number in the SIP invite message are correlated to one another in the database.

2. The network computing device of claim 1, wherein to determine to forward or reject the SIP invite message the processor device is further configured to:
confirm that the identifier and the phone number in the SIP invite message are correlated to one another in the database;
modify the SIP invite message by removing the identifier and the phone number to generate a modified SIP invite message; and
transmit the modified SIP invite message.

3. The network computing device of claim 1, wherein to determine to forward or reject the SIP invite message the processor device is further configured to:
confirm that the identifier and the phone number in the SIP invite message are not correlated in the database; and
reject the SIP invite message.

4. The network computing device of claim 1, wherein the network computing device comprises one or more of a proxy-call session control function (P-CSCF) or a serving-call session control function (S-CSCF).

5. The network computing device of claim 1, wherein the header field of the SIP invite message includes a firmware version.

6. The network computing device of claim 1,
wherein the identifier comprises an encrypted identifier that is encrypted by a public encryption key of the network computing device;
wherein the processor device is further configured to decrypt the encrypted identifier using a private encryption key.

7. The network computing device of claim 1, wherein the identifier comprises one or more of a device ID of the network computing device, a Media Access Control (MAC) address of the network computing device, or a serial number of the network computing device.

8. A method, comprising:
receiving, at a network computing device, a session initiation protocol (SIP) invite message, the SIP invite message including a header field comprising a phone number and an identifier that identifies a calling device;
querying, by the network computing device, a database that correlates each of a plurality of phone numbers to a respective one of a plurality of identifiers; and
determining, by the network computing device, to forward or reject the SIP invite message based on whether the identifier and the phone number in the SIP invite message are correlated to one another in the database.

9. The method of claim 8, wherein determining, by the network computing device, whether to forward or reject the SIP invite message comprises:
confirming, by the network computing device, the identifier and the phone number in the SIP invite message are correlated in the database; and
modifying, by the network computing device, the SIP invite message by removing the identifier and the phone number to generate a modified SIP invite message; and
transmitting, by the network computing device, the modified SIP invite message.

10. The method of claim 8, wherein determining, by the network computing device, whether to forward or reject the SIP invite message comprises:
confirming, by the network computing device, the identifier and the phone number in the SIP invite message are not correlated in the database; and
rejecting, by the network computing device, the SIP invite message.

11. The method of claim 8,
wherein the header field of the SIP invite message includes a firmware version;
wherein the identifier comprises one or more of a device ID of the network computing device, a Media Access Control (MAC) address of the network computing device, or a serial number of the network computing device;
wherein the SIP invite message is received at a proxy-call session control function (P-CSCF) or a serving-call session control function (S-CSCF) of the network computing device.

12. The method of claim 8, wherein the SIP invite message is received from an endpoint computing device comprising one or more of an embedded Multimedia Terminal Adapter (eMTA) or a mobile device;

13. The method of claim 8, wherein the database is one or more of a home subscriber server (HSS), an equipment identity register (EIR), or a device management system.

14. The method of claim 8,
wherein the identifier comprises an encrypted identifier that is encrypted by a public encryption key of the network computing device; and
wherein the method further comprises decrypting, by the network computing device, the encrypted identifier using a private encryption key of the network computing device.

15. An endpoint computing device, comprising:
a memory; and
a processor device coupled to the memory and configured to:
encrypt, using a public encryption key of a network computing device, an identifier that identifies a calling device to generate an encrypted identifier;
generate a session initiation protocol (SIP) invite message that includes a phone number and the encrypted identifier; and
transmit the SIP invite message toward the network computing device.

16. The endpoint computing device of claim 15,
wherein the SIP invite message includes a firmware version;
wherein the encrypted identifier comprises one or more of a device ID of the network computing device, a Media Access Control (MAC) address of the network computing device, or a serial number of the network computing device.

17. The endpoint computing device of claim 15, wherein the endpoint computing device comprises an embedded Multimedia Terminal Adapter (eMTA) or a mobile device.

18. The endpoint computing device of claim 15, wherein the processor device is further configured to request a public certificate associated with the network computing device from a certificate repository.

19. The endpoint computing device of claim 15, wherein the processor device is further configured to receive the phone number and the encrypted identifier from a calling device.

20. The endpoint computing device of claim 15, wherein the processor device is further configured to establish a call session or receive a rejection based on whether the encrypted identifier and the phone number of the SIP invite message are correlated in a database in electronic communication with the network computing device.
